(19) United States
(12) Patent Application Publication
(10) Pub. No.: US 2024/0014468 A1
(43) Pub. Date: Jan. 11, 2024

(54) THERMAL AND DIELECTRIC INSULATOR FOR A BATTERY PACK

(71) Applicant: FEDERAL-MOGUL POWERTRAIN LLC, Northville, MI (US)

(72) Inventors: Steven M. Galamba, West Chester, PA (US); Alexis Zambino Mason, Flagstaff, AZ (US); Daniel A. Rowcotsky, Dreshar, PA (US)

(21) Appl. No.: 18/219,065

(22) Filed: Jul. 6, 2023

Related U.S. Application Data
(60) Provisional application No. 63/359,022, filed on Jul. 7, 2022.

(51) Int. Cl. H01M 10/658; H01M 50/249; H01M 50/293

(52) U.S. Cl. CPC H01M 10/658; H01M 50/249; H01M 50/293; H01M 2220/20

(57) ABSTRACT

A flexible thermal insulator for an electric vehicle battery pack includes a first laminated outer layer bounded by a first outer layer periphery and a second laminated outer layer bounded by a second outer layer periphery. The first and second laminated outer layers each include respective first and second outer heat-resistant layers bonded to respective first and second heat-resistant outer coatings. An intermediate layer is sandwiched between the first laminated outer layer and the second laminated outer layer. A first circumferentially continuous, annular spacer is sandwiched between the first laminated outer layer and the intermediate layer to define and bound a first air pocket between the first laminated outer layer and the intermediate layer. A second circumferentially continuous, annular spacer is sandwiched between the second laminated outer layer and the intermediate layer to define and bound a second air pocket between the second laminated outer layer and the intermediate layer.

### CROSS-REFERENCE TO RELATED APPLICATION

This application claims the benefit of U.S. Provisional Application Ser. No. 63/359,022, filed Jul. 7, 2022, which is incorporated herein by reference in its entirety.

### BACKGROUND OF THE INVENTION

### 1. Technical Field

This invention relates generally to thermal and dielectric insulators, and more particularly to thermal and dielectric insulators for inhibiting flame propagation within and from a battery pack of an electric vehicle.

### 2. Related Art

It is known to contain or shield battery packs, including those used in electric vehicle applications, in thermal insulation. A common material used to form such thermal insulation is fiberglass fabric. Although the fiberglass fabric insulation provides an acceptable level of protection against contamination and environmental temperatures during normal use, the fiberglass fabric insulation does not provide a desired level of protection against flame propagation outwardly from the battery pack or between cells of the battery pack, such as may be experienced in a thermal runaway condition of one or more cells of the electric vehicle battery pack. It is desired to provide insulation protection against flame propagation outwardly from the battery pack or between cells of the battery pack. It is further desired to provide thermal insulation that provides dielectric protection to the battery pack. Further yet, it is desired to provide a thermal insulator that is relatively thin, that is lightweight and that mitigates tolerance stack-up issues between cells.

### SUMMARY OF THE INVENTION

It is an object of the present disclosure to provide a thermal insulator for use with an electric vehicle battery pack that addresses at least the desires to inhibit the propagation of flame from the battery pack and between cells of the battery pack, to provide dielectric protection to the battery pack, to minimize weight of the battery pack, and to minimize issues associated with tolerance stack-up of thermal insulator between cells of the battery pack.

It is a further object to inhibit the propagation of flame from the battery pack and between cells of the battery pack for 5 minutes at a temperature of 1000° C.

It is a further object to inhibit the propagation of flame from the battery pack and between cells of the battery pack for upwards to 10 minutes at a temperature of 1000° C.

It is a further object of the present disclosure to provide a thermal insulator for use with an electric vehicle battery pack that is flexible, thereby facilitating conformability of the thermal insulator about the battery pack and between cells of the battery pack.

It is a further object of the present disclosure to provide a thermal insulator for an electric vehicle battery pack that is lightweight, that has a low profile to minimize the amount of space occupied by the thermal insulator, and that is economical in manufacture and in use.

One aspect of the invention provides a flexible thermal insulator for an electric vehicle battery pack. The flexible thermal insulator includes a first laminated outer layer bounded by a first outer layer periphery and a second laminated outer layer bounded by a second outer layer periphery. The first laminated outer layer and the second laminated outer layer are generally planar and include respective first and second outer heat-resistant layers bonded to respective first and second impervious, heat-resistant outer coatings. An intermediate layer is sandwiched between the first laminated outer layer and the second laminated outer layer. The intermediate layer includes a fabric layer of heat-resistant material. A first spacer is sandwiched between the first laminated outer layer and the intermediate layer. The first spacer has a circumferentially continuous wall with an outer first spacer periphery and an inner first spacer periphery. The inner first spacer periphery bounds a space forming a first air pocket between the first laminated outer layer and the intermediate layer. A second spacer is sandwiched between the second laminated outer layer and the intermediate layer. The second spacer has a circumferentially continuous wall with an outer second spacer periphery and an inner second spacer periphery. The inner second spacer periphery bounds a space forming a second air pocket between the second laminated outer layer and the intermediate layer.

In accordance with another aspect of the invention, the thicknesses of the first and second spacers and the first and second air pockets are compressible, thereby allowing the stack-up tolerances defining the total width of the flexible thermal insulator to be relaxed, thus making the manufacture of the flexible thermal insulator economical, and the assembly of the flexible thermal insulator between adjacent cells to be simplified.

In accordance with another aspect of the invention, the separate layers of the flexible thermal insulator can be fixed to one another via an adhesive, and/or mechanical mechanisms, including sewing and/or fasteners.

In accordance with another aspect of the invention, the first and second outer heat-resistant layers can be provided as woven fiberglass layers, wherein the weave pattern used to construct the outer woven fiberglass layers can be a tight plain weave pattern to provide maximum heat insulation.

In accordance with another aspect of the invention, the impervious, heat-resistant outer coating is one of a mica-based or silica-based coating.

In accordance with another aspect of the invention, the outer fiberglass layer has a thickness between about 0.1 to 0.3 mm.

In accordance with another aspect of the invention, the fabric layer of the intermediate layer is one of an impervious sheet material, woven fabric, or nonwoven fabric.

In accordance with another aspect of the invention, the fabric layer of the intermediate layer is a silicone sheet.

In accordance with another aspect of the invention, the fabric layer of the intermediate layer is a woven, impregnated layer.

In accordance with another aspect of the invention, the woven, impregnated layer is a fiberglass woven layer impregnated with silicone.

In accordance with another aspect of the invention, the fabric layer of the intermediate layer is a silica-based nonwoven layer.

In accordance with another aspect of the invention, the fabric layer of the intermediate layer is an alkaline earth silicate composition.

In accordance with another aspect of the invention, the intermediate layer has a thickness between about 2.9 to 3.1 mm.

In accordance with another aspect of the invention, each of the first and second spacers is one of a woven or nonwoven material.

In accordance with another aspect of the invention, each of the first and second spacers is a woven, impregnated layer.

In accordance with another aspect of the invention, the woven, impregnated layer is a fiberglass woven layer impregnated with silicone.

In accordance with another aspect of the invention, each of the first and second spacers is a silica-based nonwoven layer.

In accordance with another aspect of the invention, each of the first and second spacers is an alkaline earth silicate composition.

In accordance with another aspect of the invention, each of the first and second spacers has a thickness between about 1.4 to 1.6 mm.

In accordance with another aspect of the invention, the wall has a maximum thickness of 5 mm, thereby having a low profile to enhance design options and reduce weight.

In accordance with another aspect of the invention, an electric vehicle battery pack is provided. The electric vehicle battery pack includes a housing, a plurality of cells bounded by the housing, and a flexible thermal insulator disposed between adjacent ones of the plurality of cells. The flexible thermal insulator includes a first laminated outer layer including a first impervious, heat-resistant outer coating bonded to a first heat-resistant fabric. Further, the flexible thermal insulator includes a second laminated outer layer including a second impervious, heat-resistant outer coating bonded to a second heat-resistant fabric. Further, a heat-resistant intermediate layer is sandwiched between the first laminated outer layer and the second laminated outer layer. A first spacer is sandwiched between the first laminated outer layer and the heat-resistant intermediate layer. The first spacer has a circumferentially continuous wall with an outer first spacer periphery and an inner first spacer periphery. The inner first spacer periphery bounds a space forming a first air pocket between the first laminated outer layer and the heat-resistant intermediate layer. A second spacer is sandwiched between the second laminated outer layer and the heat-resistant intermediate layer. The second spacer has a circumferentially continuous wall with an outer second spacer periphery and an inner second spacer periphery. The inner second spacer periphery bounds a space forming a second air pocket between the second laminated outer layer and the heat-resistant intermediate layer.

In accordance with another aspect of the invention, the first and second heat-resistant fabrics each have a thickness between about 0.1 mm to 0.3 mm, the intermediate layer has a thickness between about 2.9 mm to 3.1 mm, and the first and second spacers each have a thickness between about 1.4 mm to 1.6 mm.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a schematic perspective view of an electric motor vehicle having a battery pack with a thermal insulator constructed in accordance with an aspect of the invention;

FIGS. 2A-2C illustrate a schematic representation of a plurality of cells in an electric vehicle battery pack in accordance with the prior art, not having a thermal insulator in accordance with the invention, undergoing a thermal runaway condition with a flame propagating without hindrance from a location of flame initiation (FIG. 2A) throughout the battery pack in less than 5 minutes at a temperature of 1000° C. (FIG. 2C);

FIGS. 3A-3C are views similar to FIGS. 2A-2C, with the battery pack including the thermal insulator in accordance with the invention, with the thermal insulator shown suppressing and inhibiting flame propagating from a location of an initial thermal runaway condition (FIG. 3A) throughout the battery pack for upwards to 10 minutes or more at a temperature of 1000° C. (FIG. 3C);

FIG. 4A is a perspective view of a thermal insulator in accordance with one embodiment of the disclosure; and

FIG. 4B is a schematic, exploded perspective view of the thermal insulator of FIG. 4A.

### DETAILED DESCRIPTION OF PREFERRED EMBODIMENTS

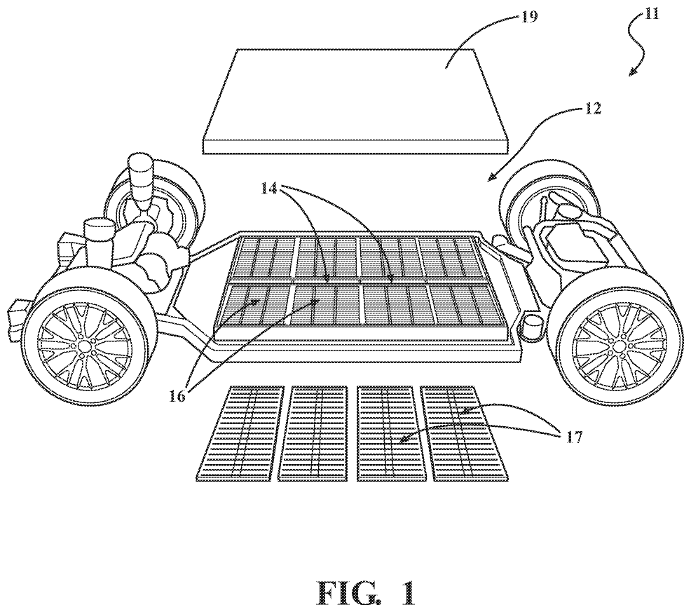

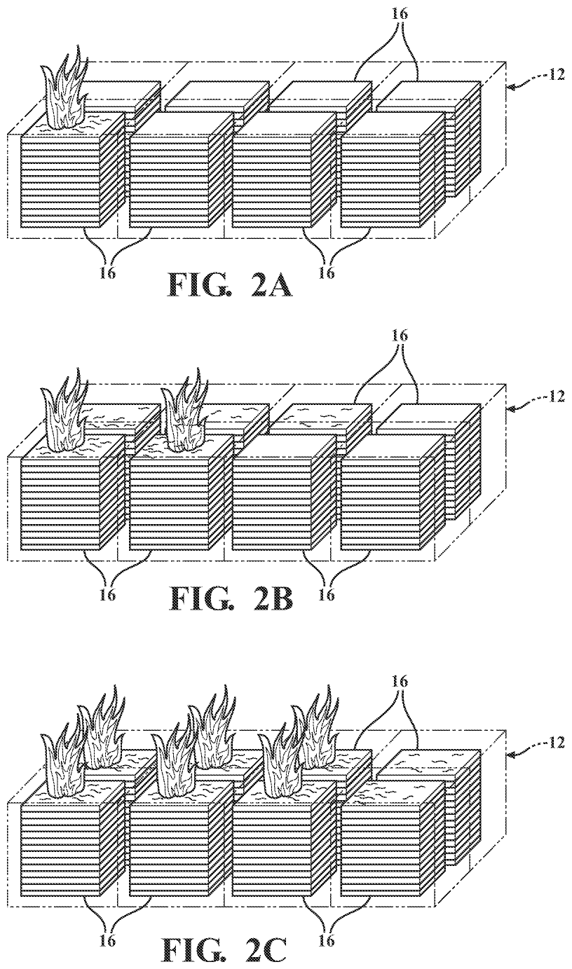

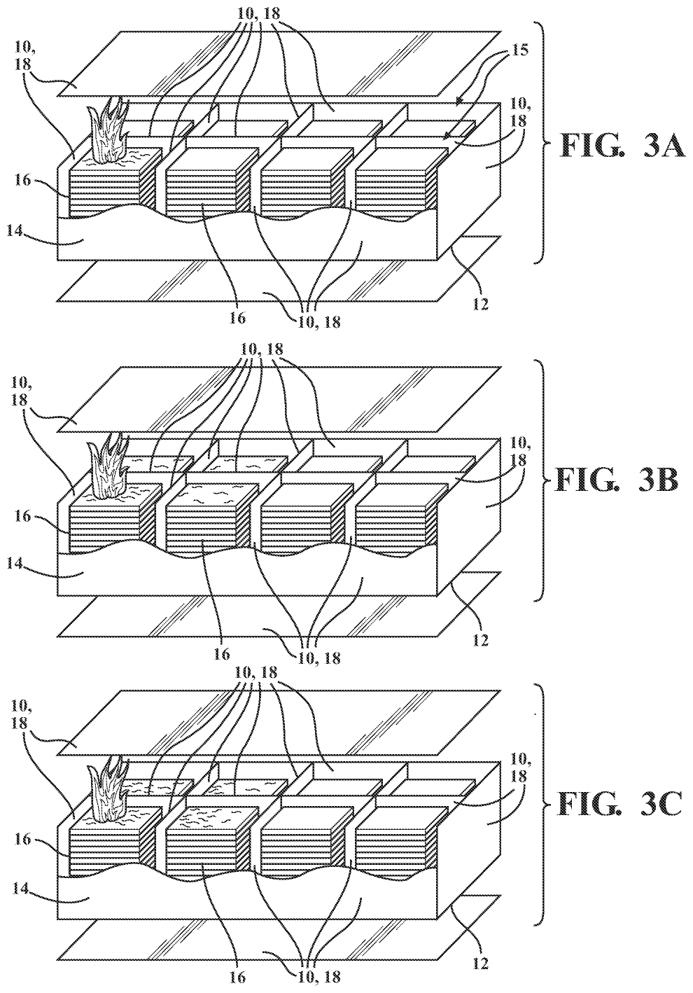

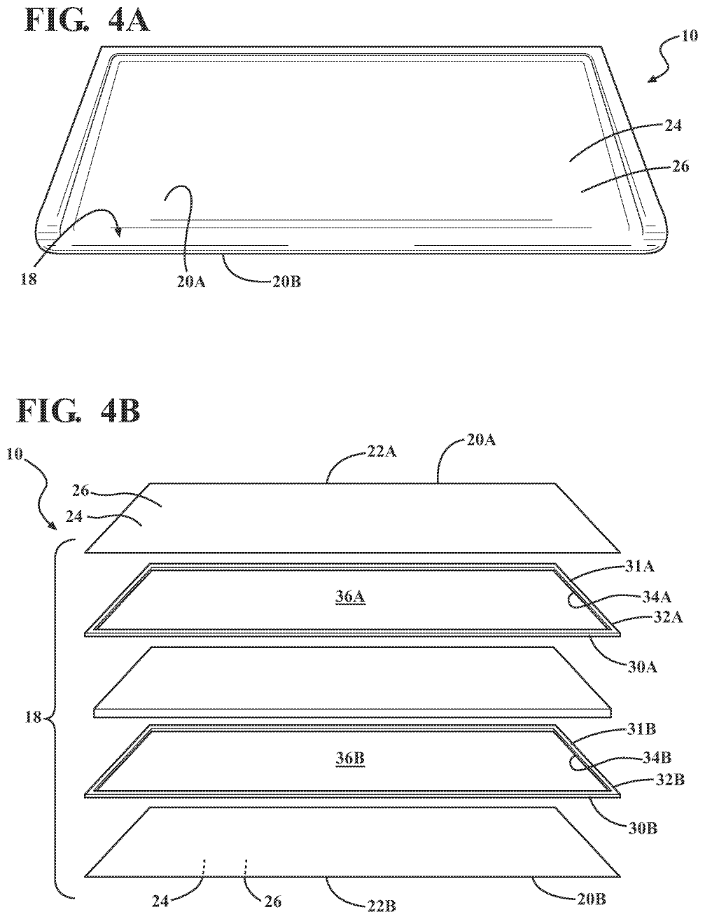

Referring in more detail to the drawings, FIG. 1 illustrates a motor vehicle, shown as an electrically powered motor vehicle, also referred to as electric vehicle 11, having a battery pack 12, such as a lithium-ion battery pack, configured with a plurality of flexible, multilayered thermal insulators, referred to hereafter as thermal insulators 10, (FIGS. 3A-3C and 4A-4B) constructed in accordance with an aspect of the invention. The electric vehicle battery pack 12 includes one or more module housings 14 bounding a plurality of cells 16. The separate cells 16 can be covered with module lids 17 and/or the separate cells 16 can be covered with a unitary battery pack lid 19. During normal use, and including in non-normal situations, such as in a vehicle crash condition or some other condition causing an impact force, damage, or malfunction to battery pack 12, a thermal runaway condition originating in any one of the cells 16 is controlled via the thermal insulator 10. A separate thermal insulator 10 is disposed between adjacent ones of the cells 16, and as shown, can also be disposed in overlying relation to the cells 16, whether beneath and/or overtop the module lids 17 and/or battery pack lid 19, such that flame propagation is prevented between cells 16, such as for 10 minutes or more, and an outer surface temperature of the battery housing 14, also referred to as case, is maintained to be less than 500° C. at a temperature of 1000° C. for up to 10 minutes or more.

As best shown schematically in FIG. 4B, each thermal insulator 10 includes a composite wall, also referred to as multilayered wall, and referred to hereafter as wall 18, which overlies the plurality of cells 16 and extends between the cells 16 to effectively isolate and insulate each cell 16 from an adjacent cell 16. The wall 18 includes a first laminated outer layer 20A bounded by a first outer layer periphery 22A and a second laminated outer layer 20B bounded by a second outer layer periphery 22B. The first laminated outer layer 20A and the second laminated outer layer 20B are generally flat (planar), though highly flexible, and include an outer heat-resistant layer, such as an outer fiberglass layer 24, bonded to an impervious, heat-resistant outer coating 26. The outer coating 26 can be applied to the outer fiberglass layer 24 via any suitable coating process, including spraying, dipping, and hot-press, by way of example and without limitation. An intermediate layer 28 is sandwiched between the first laminated outer layer 20A and the second laminated outer layer 20B. The intermediate layer 28 is fabricated as a fabric layer of heat-resistant material. A first frame, also referred to as first spacer 30A, is sandwiched between the first laminated outer layer 20A and the intermediate layer 28. The first spacer 30A has an annular, circumferentially continuous wall 31A with an outer first spacer periphery 32A and an inner first spacer periphery 34A. The outer first spacer periphery 32A is fixed adjacent the first outer layer periphery 22A and the inner first spacer periphery 34A bounds a space forming and defining a first air pocket 36A (FIG. 4B) between the first laminated outer layer 20A and the intermediate layer 28. An uncompressed thickness of the first air pocket 36A is defined by the thickness of the first spacer 30A. Accordingly, the first spacer 30A functions to form a standoff (gap, also referred to as space/air pocket) between first outer layer 20A and intermediated layer 28. A second spacer 30B is sandwiched between the second laminated outer layer 20B and the intermediate layer 28. The second spacer 30B has an annular, circumferentially continuous wall 31B with an outer second spacer periphery 32B and an inner second spacer periphery 34B. The outer second spacer periphery 32B is fixed adjacent the second outer layer periphery 22B and the inner second spacer periphery 34B bounds a space forming and defining a second air pocket 36B (FIG. 4B) between the second laminated outer layer 20B and the intermediate layer 28. An uncompressed thickness of the second air pocket 36B is defined by the thickness of the second spacer 30B. Accordingly, the second spacer 30B functions to form a standoff (gap, also referred to as space/air pocket) between second outer layer 20B and intermediated layer 28. The thicknesses of the first and second spacers 30A, 30B, and thus, the first and second air pockets 36A, 36B, are highly compressible, thereby allowing the stack-up tolerances defining the total thickness of the flexible thermal insulator 10 to be relaxed without concern for the ability of the insulators 10 to fit within spaces between adjacent cells 16. Further, compressibility of the insulator 10 makes the manufacture of the flexible thermal insulator 10 economical, given the tolerance stack-up does not need to be as tight as would be the case absent the compressibility, and further yet, the tolerance of the space between the cells 16 does not need to be as tightly controlled, and even further yet, assembly of the compressible flexible thermal insulator between adjacent cells 16 is simplified.

In accordance with another aspect of the invention, the separate layers of the flexible thermal insulator 10, including the first laminated outer layer 20A, the second laminated outer layer 20B, the intermediate layer 28, and the first and second spacers 30B, can be fixed to one another via an adhesive, and/or mechanical mechanisms, including sewing and/or fastener mechanism, including mechanical fasteners, such as rivets, snaps, hook and loop, or otherwise.

In accordance with a further aspect of the invention, the outer fiberglass layer 24 can be woven via a tight weave pattern, with a plain weave pattern providing the optimal tightness, and having a thickness between 0.1 to 0.3 mm. The impervious, heat-resistant outer coating bonded to the outer fiberglass layer 24 can be provided as one of a mica-based or silica-based coating.

In accordance with a further aspect of the invention, the fabric layer of the intermediate layer 28 is one of an impervious sheet material, woven material, or nonwoven material having a thickness between about 2.9 to 3.1 mm. In accordance with one aspect, the fabric layer of the intermediate layer 28 is provided as an impervious silicone sheet. In accordance with another aspect, the fabric layer of the intermediate layer 28 can be provided as a woven, impregnated layer, wherein the woven, impregnated layer is provided as a woven fiberglass layer impregnated with silicone, wherein the silicone renders the layer impervious or substantially impervious (more impervious than without the silicone, but less than 100% impervious). In accordance with another aspect, the fabric layer of said intermediate layer 28 can be provided as a silica-based nonwoven layer. In accordance with another aspect, the fabric layer of said intermediate layer 28 can be provided as an alkaline earth silicate composition.

In accordance with a further aspect of the invention, each of the first and second spacers 30A, 30B is one of a woven or nonwoven material having a thickness between about 1.4 to 1.6 mm. In accordance with one aspect, each of the first and second spacers 30A, 30B can be formed as a woven, impregnated layer, wherein the woven, impregnated layer can be provided as a woven fiberglass layer impregnated with silicone. In accordance with another aspect, each of the first and second spacers 30A, 30B can be provided as a silica-based nonwoven layer. In accordance with yet another aspect, each of the first and second spacers 30A, 30B can be provided as an alkaline earth silicate composition.

The thermal insulator 10 has a maximum thickness extending between outermost surfaces of the outer first and second laminated outer layers 20A, 20B of about 5 mm, wherein the thickness is desirably compressible, particularly the thicknesses of the first and second spacers 30A, 30B, and thus, the thicknesses of the first and second air pockets 36A, 36B, thereby relaxing the tolerance of the space needed between adjacent cells 16 of the battery pack 12 to accommodate disposal of the thermal insulator 10 therein. Accordingly, the size of the battery pack 12 is able to be minimized, without concern of increasing the space needed to accommodate the thermal insulators 10.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A flexible thermal insulator for an electric vehicle battery pack, comprising:
a first laminated outer layer including a first impervious, heat-resistant outer coating bonded to a first heat-resistant fabric;
a second laminated outer layer including a second impervious, heat-resistant outer coating bonded to a second heat-resistant fabric;
a heat-resistant intermediate layer sandwiched between the first laminated outer layer and the second laminated outer layer;
a first spacer sandwiched between the first laminated outer layer and the heat-resistant intermediate layer, the first spacer having a circumferentially continuous wall with an outer first spacer periphery and an inner first spacer periphery, the inner first spacer periphery bounding a space forming a first air pocket between the first laminated outer layer and the heat-resistant intermediate layer; and
a second spacer sandwiched between the second laminated outer layer and the heat-resistant intermediate layer, the second spacer having a circumferentially continuous wall with an outer second spacer periphery and an inner second spacer periphery, the inner second spacer periphery bounding a space forming a second air pocket between the second laminated outer layer and the heat-resistant intermediate layer.

2. The flexible thermal insulator of claim 1, wherein the first and second heat-resistant fabrics are fiberglass fabrics.

3. The flexible thermal insulator of claim 1, wherein the first and second impervious, heat-resistant outer coatings are one of a mica-based coating or a silica-based coating.

4. The flexible thermal insulator of claim 3, wherein the first and second heat-resistant fabrics each have a thickness between 0.1 to 0.3 mm.

5. The flexible thermal insulator of claim 4, wherein the fabric layer of the intermediate layer is one of an impervious sheet material, a woven fabric, or a nonwoven fabric.

6. The flexible thermal insulator of claim 5, wherein the fabric layer of the intermediate layer is a silicone sheet.

7. The flexible thermal insulator of claim 5, wherein the fabric layer of the intermediate layer is a woven fiberglass layer impregnated with silicone.

8. The flexible thermal insulator of claim 5, wherein the fabric layer of the intermediate layer is a silica-based nonwoven layer.

9. The flexible thermal insulator of claim 5, wherein the fabric layer of the intermediate layer is an alkaline earth silicate composition.

10. The flexible thermal insulator of claim 5, wherein the intermediate layer has a thickness between 2.9 to 3.1 mm.

11. The flexible thermal insulator of any one of claim 1, wherein each of the first and second spacers is one of a woven or nonwoven material.

12. The flexible thermal insulator of claim 11, wherein each of the first and second spacers is a woven layer impregnated with silicone.

13. The flexible thermal insulator of claim 11, wherein each of the first and second spacers is a silica-based nonwoven layer.

14. The flexible thermal insulator of claim 11, wherein each of the first and second spacers is an alkaline earth silicate composition.

15. The flexible thermal insulator of claim 10, wherein each of the first and second spacers has a thickness between 1.4 to 1.6 mm.

16. An electric vehicle battery pack, comprising:
a housing;
a plurality of cells bounded by said housing; and
a flexible thermal insulator disposed between adjacent ones of said plurality of cells, the flexible thermal insulator comprising:
a first laminated outer layer including a first impervious, heat-resistant outer coating bonded to a first heat-resistant fabric;
a second laminated outer layer including a second impervious, heat-resistant outer coating bonded to a second heat-resistant fabric;
a heat-resistant intermediate layer sandwiched between said first laminated outer layer and said second laminated outer layer;
a first spacer sandwiched between said first laminated outer layer and said heat-resistant intermediate layer, said first spacer having a circumferentially continuous wall with an outer first spacer periphery and an inner first spacer periphery, said inner first spacer periphery bounding a space forming a first air pocket between said first laminated outer layer and said heat-resistant intermediate layer; and
a second spacer sandwiched between said second laminated outer layer and said heat-resistant intermediate layer, said second spacer having a circumferentially continuous wall with an outer second spacer periphery and an inner second spacer periphery, said inner second spacer periphery bounding a space forming a second air pocket between said second laminated outer layer and said heat-resistant intermediate layer.

17. The electric vehicle battery pack of claim 16, wherein the first and second heat-resistant fabrics each have a thickness between about 0.1 to 0.3 mm, the intermediate layer has a thickness between about 2.9 to 3.1 mm, and the first and second spacers each have a thickness between about 1.4 to 1.6 mm.

18. The electric vehicle battery pack of claim 16, wherein the first and second impervious, heat-resistant outer coatings are one of a mica-based coating or a silica-based coating.

19. The electric vehicle battery pack of claim 16, wherein the heat-resistant intermediate layer is one of an impervious sheet material, a woven fabric, or a nonwoven fabric.

20. The electric vehicle battery pack of claim 16, wherein each of the first and second spacers is one of a woven or nonwoven material.
